(19) United States
(12) Patent Application Publication
(10) Pub. No.: US 2019/0131065 A1
(43) Pub. Date: May 2, 2019

(54) METHOD AND AN APPARATUS FOR THE SEGMENTATION OF ND-FE-B MAGNETS

(71) Applicant: Yantai Shougang Magnetic Materials, Inc., Yantai (CN)

(72) Inventors: Daoning Jia, Yantai (CN); Zhongjie Peng, Yantai (CN); Guangyang Liu, Yantai (CN)

(21) Appl. No.: 16/178,530

(22) Filed: Nov. 1, 2018

(30) Foreign Application Priority Data
Nov. 1, 2017 (CN) 201711056569.X

(51) Int. Cl. H01F 41/02; B32B 7/12; B32B 15/01; B32B 38/16; B32B 37/12; H01F 1/057

(52) U.S. Cl. CPC H01F 41/0266; B32B 7/12; B32B 15/011; B32B 38/162; B32B 2307/206; H01F 1/057; B32B 2307/208; B32B 2037/1253; B32B 37/12

(57) ABSTRACT

A method of segmenting a cured Nd—Fe—B magnet includes providing a first and a second Nd—Fe—B magnet. The surface of the Nd—Fe—B magnets is cleaned. An insulating adhesive is deposited on the surface of the first Nd—Fe—B magnet. Then, the first Nd—Fe—B magnet is cured. Next, a layer of the insulating adhesive is deposited on the surface of the Nd—Fe—B magnets. Then, the first Nd—Fe—B magnet and the second Nd—Fe—B magnet are stacked to produce a stacked Nd—Fe—B magnet. After stacking, a predetermined clamping pressure is applied to the stacked Nd—Fe—B magnet. The stacked Nd—Fe—B magnet is then cured to produce a cured Nd—Fe—B magnet. The cured Nd—Fe—B magnet is then machined into a plurality of small Nd—Fe—B magnets. The step of depositing the insulating adhesives is further defined as depositing a plurality of beads of the insulating adhesive onto the surface of the first Nd—Fe—B magnet.

### CROSS REFERENCE TO RELATED APPLICATION

This application claims priority to Chinese application serial number CN201711056569.X filed on Nov. 1, 2017, the entire disclosure of which is incorporated herein by reference in its entirety.

### BACKGROUND OF THE INVENTION

### 1. Field of the Invention

The present invention generally relates to a method and an apparatus for the segmentation of Nd—Fe—B magnets.

### 2. Description of the Prior Art

With the development of new energy vehicles and wind power high speed motor, there is a requirement for Nd—Fe—B magnets to operate properly at a high speed. Accordingly, rotor eddy-current loss has become a key factor that affects the reliability of permanent magnets when operating at a high speed. Because the rotors have poor heat dissipation, eddy-currents generated by the permanent magnets spun at a high speed will increase the rotor's temperature thereby causes the permanent magnets to demagnetize. To resolve this problem, a plurality of Nd—Fe—B magnets can be bonded together and segmented, with each Nd—Fe—B magnets being an independent body and insulated from each other, to effectively reduce the rotor eddy-current loss and the operation temperature of the Nd—Fe—B magnets.

Traditional methods of bonding the Nd—Fe—B permanent magnets include using glass beads mixed together with adhesives. Then, the glass beads and the adhesives are applied to the surface of the Nd—Fe—B permanent magnets. A clamping tool apparatus is used to sandwich the Nd—Fe—B permanent magnets together. Then, the Nd—Fe—B permanent magnets are cured. However, there are many drawbacks associated with the traditional method. Specifically, mixing the glass beads reduces the strength of the adhesive. In addition, the glass beads are not all uniform in size; therefore, it is difficult to have a layer of adhesives between the permanent magnet that has uniform thickness. Furthermore, the use of glass beads creates a large gap between the Nd—Fe—B permanent magnets. When sandwiching the Nd—Fe—B permanent magnets, some of the glass beads may move or be crushed, this makes it difficult to maintain the insulation characteristics between the Nd—Fe—B permanent magnets. Therefore, the success rate of using the traditional method to bond the Nd—Fe—B permanent magnets is very low and, often, additional tests are required to ensure proper insulation exists between the Nd—Fe—B permanent magnets.

One such a method is disclosed in Chinese Patent 101763929 B. The method includes a first step of cleaning the plurality of the Nd—Fe—B magnet including the grease and the rust to remove the grease and the rust. The next step of the method is depositing a layer of insulating adhesive including a plurality of glass beads on the surface of the Nd—Fe—B magnets. Then, the layer of insulating adhesive is sandwiched between a first Nd—Fe—B magnet and a second Nd—Fe—B permanent magnet by stacking the second Nd—Fe—B permanent magnet on the first Nd—Fe—B permanent magnet. Next, a predetermined clamping pressure is applied to the first Nd—Fe—B permanent magnet and the second Nd—Fe—B permanent magnet to produce a stacked Nd—Fe—B permanent magnet. The stacked Nd—Fe—B magnet is then cured.

### SUMMARY OF THE INVENTION

The present invention provides proper spacing between each one of the Nd—Fe—B magnets in a cured Nd—Fe—B magnet. At the same time, the present invention ensure effective insulation between each one of the Nd—Fe—B magnets in the cured Nd—Fe—B magnet. Further, the present invention provides a method of segmenting the cured Nd—Fe—B magnet, which produces more than one finished product thereby improving manufacturing efficiency. Accordingly, the excessive insulating adhesive around the cured Nd—Fe—B magnet can be effectively disposed.

It is one aspect of the present invention to provide a method of segmenting a cured Nd—Fe—B magnet. The method includes a first step of providing a first Nd—Fe—B magnet and a second Nd—Fe—B magnet. The first Nd—Fe—B magnet and the second Nd—Fe—B magnet include rust and grease disposed on a surface of the first Nd—Fe—B magnet and the second Nd—Fe—B magnet. The next step of the method is cleaning the surface of the first Nd—Fe—B magnet and the second Nd—Fe—B magnet to remove the rust and the grease from the first Nd—Fe—B magnet and the second Nd—Fe—B magnet. Then, an insulating adhesive is deposited onto the surface of the first Nd—Fe—B magnet. After depositing the insulating adhesive, the first Nd—Fe—B magnet including the insulating adhesive is cured. After curing the surface of the first Nd—Fe—B magnet including the insulating adhesive, the next step of the method is depositing a layer of the insulating adhesive the surface of the first Nd—Fe—B magnet and the second Nd—Fe—B magnet. Then, the first Nd—Fe—B magnet and the second Nd—Fe—B magnet are stacked to produce a stacked Nd—Fe—B magnet. During stacking, the layer of the insulating adhesive on the surface of the second Nd—Fe—B magnet and the layer of insulating adhesive and the beads of the first adhesive on the surface of the first Nd—Fe—B magnet are sandwiched between the first Nd—Fe—B magnet and the second Nd—Fe—B magnet. After stacking, a predetermined clamping pressure is applied to the stacked Nd—Fe—B magnet. The stacked Nd—Fe—B magnet is then cured to produce a cured Nd—Fe—B magnet. Next, the cured Nd—Fe—B magnet is machined to divide the cured Nd—Fe—B magnet into a plurality of small Nd—Fe—B magnets. The step of depositing the insulating adhesives is further defined as depositing a plurality of beads of the insulating adhesive onto the surface of the first Nd—Fe—B magnet. By disposing and curing the beads of the insulating adhesive on the surface of the first Nd—Fe—B magnet, the beads hardens thereby allowing the beads to properly space the first Nd—Fe—B magnet from the second Nd—Fe—B magnet when the first Nd—Fe—B magnet and the second Nd—Fe—B magnet are stacked together. At the same time, the beads are also elastically deformable to prevent the beads from being crushed when stacking the first Nd—Fe—B magnet and the second Nd—Fe—B magnet.

It is another aspect of the present invention to provide a cured Nd—Fe—B magnet. The cured Nd—Fe—B magnet includes at least one first Nd—Fe—B magnet and at least one second Nd—Fe—B magnet disposed spaced and generally parallel to one another. A layer of an insulating adhesive is disposed between the at least one first Nd—Fe—B magnet and the at least one second Nd—Fe—B magnet. A plurality of cured beads of the insulating adhesive is disposed in the layer between the at least one first Nd—Fe—B magnet and the at least one second Nd—Fe—B magnet to space and insulate the at least one first Nd—Fe—B magnet from the at least one second Nd—Fe—B magnet.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic diagram of the method of segmentation of Nd—Fe—B magnets in accordance with one embodiment of the present invention;

FIG. 2 is cross-sectional perspective view of a cured Nd—Fe—B magnet in accordance with one embodiment of the present invention;

FIG. 3 is a side view of an apparatus for making the cured Nd—Fe—B magnet in accordance with one embodiment of the present invention; and

FIG. 4 is a schematic view of the method of segmentation of the Nd—Fe—B magnets.

### DESCRIPTION OF THE ENABLING EMBODIMENT

Referring to the Figures, wherein like numerals indicate corresponding parts throughout the several views, it is one aspect of the present invention to provide a method of segmenting a cured Nd—Fe—B magnet 20.

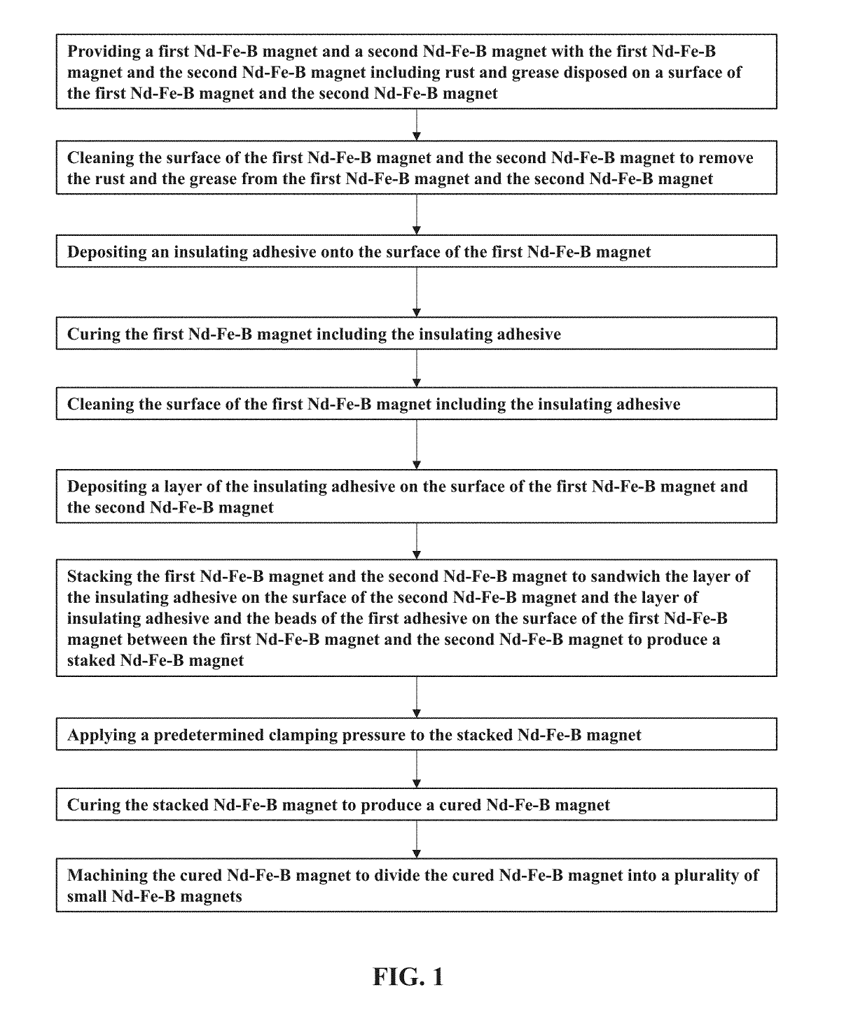

As best illustrated in FIG. 1, the method in accordance with one embodiment of the present invention includes a first step of providing a first Nd—Fe—B magnet 22 and a second Nd—Fe—B magnet 24. The first Nd—Fe—B magnet 22 and the second Nd—Fe—B magnet 24 includes rust and grease disposed on a surface of the first Nd—Fe—B magnet 22 and the second Nd—Fe—B magnet 24. It should be appreciated that the rust and grease may be disposed on multiple surfaces of the Nd—Fe—B magnets. In one embodiment of the present invention, the first Nd—Fe—B magnet 22 and the second Nd—Fe—B magnet 24 are permanent Nd—Fe—B magnets or permanent Nd—Fe—B magnets containing Terbium or Dysprosium diffused therein.

The next step of the method is cleaning the surface of the first Nd—Fe—B magnet 22 and the second Nd—Fe—B magnet 24. It should be appreciated that the step of cleaning can be further defined as acid washing, phosphating, or sand blasting the surface of the first Nd—Fe—B magnet 22 and the second Nd—Fe—B magnet 24. The step of cleaning the surface of the first Nd—Fe—B magnet 22 and the second Nd—Fe—B magnet 24 includes a step of removing the rust and the grease from the surface of the first Nd—Fe—B magnet 22 and the second Nd—Fe—B magnet 24. The step of removing the rust and the grease is further defined as washing the surface of the first Nd—Fe—B magnet 22 and the second Nd—Fe—B magnet 24 using a solution to remove the grease and the rust from the first Nd—Fe—B magnet 22 and the second Nd—Fe—B magnet 24. It should be appreciated that the solution can be selected from at least one alcohol or acetone. After washing, the surface of the first Nd—Fe—B magnet 22 and the second Nd—Fe—B 24 is activated by subjecting the surface of the first Nd—Fe—B magnet 22 and the second Nd—Fe—B magnet 24 to a plasma cleaning process. It should be appreciated that the plasma cleaning process can be performed using a low temperature plasma or a plasma flame.

Then, an insulating adhesive is disposed onto the surface of the first Nd—Fe—B magnet 22. During the step of depositing the insulating adhesives, a plurality of beads 26 of the insulating adhesive are disposed onto the surface of the first Nd—Fe—B magnet 22. In one embodiment of the present invention, at least three beads 26 are disposed on onto the surface of the first Nd—Fe—B magnet 22. It should be appreciated that the insulating adhesive includes, but not limited to, an epoxy resin. Next, the first Nd—Fe—B magnet 22 including the insulating adhesive is cured by heating the first Nd—Fe—B magnet 22 including the insulating adhesive in a furnace under a curing temperature of between 20° C. to 200° C. for a curing duration of between 0.1 hour and 24 hours to solidify the beads 26 of the insulating adhesive. By solidifying the beads 26 of the insulating adhesive, the beads 26 hardens thereby allowing the beads 26 to properly space the first Nd—Fe—B magnet 22 from the second Nd—Fe—B magnet 24 when the first Nd—Fe—B magnet 22 and the second Nd—Fe—B magnet 24 are stacked together. At the same time, the beads 26 are also elastically deformable to prevent the beads 26 from being crushed when stacking the first Nd—Fe—B magnet 22 and the second Nd—Fe—B magnet 24. It should be appreciated that the beads 26 typically has a thickness T of between 0.03 mm and 0.5 mm to ensure effective insulation between the first Nd—Fe—B magnet 22 and the second Nd—Fe—B magnet 24.

Next, the surface of the first Nd—Fe—B magnet 22 including the insulating adhesive is further cleaned by acid washing, phosphating, or sand blasting the surface of the first Nd—Fe—B magnet 22. The step of cleaning the surface of the first Nd—Fe—B magnet 22 including the insulating adhesive can further include a step of washing the surface of the first Nd—Fe—B magnet 22 using the solution selected from at least one alcohol or acetone. After washing, the surface of the first Nd—Fe—B magnet 22 including the insulating adhesive is activated by subjecting the surface of the first Nd—Fe—B magnet 22 including the insulating adhesive to a plasma cleaning process.

After cleaning, a layer 28 of the insulating adhesive is deposited on the surface of the first Nd—Fe—B magnet 22 and the second Nd—Fe—B magnet 24. Then, the first Nd—Fe—B magnet 22 and the second Nd—Fe—B magnet 22 are stacked to produce a stacked Nd—Fe—B magnet. During stacking, the layer 28 of the insulating adhesive on the surface of the second Nd—Fe—B magnet 22 and the layer 28 of insulating adhesive and the beads 26 of the first adhesive on the surface of the first Nd—Fe—B magnet 22 are sandwiched between the first Nd—Fe—B magnet 22 and the second Nd—Fe—B magnet 24. A predetermined clamping pressure is then applied to the stacked Nd—Fe—B magnet. To apply the predetermined clamping pressure, the stacked Nd—Fe—B magnet is placed in a clamping tool and the predetermined pressure of between 0.1 MPa and 20 MPa is applied to the stacked Nd—Fe—B magnet. This is to ensure that the layer 28 of insulating adhesive is evenly spread, i.e. having a uniform thickness, between the first Nd—Fe—B magnet 22 and the second Nd—Fe—B magnet 24. It should be appreciated that, in one embodiment of the present invention, the thickness of the layer 26 is equivalent to the thickness of the beads 28, e.g. between 0.03 mm and 0.5 mm. In one embodiment of the present invention, the stack Nd—Fe—B magnet only includes a first Nd—Fe—B magnet 22 and the second Nd—Fe—B magnet 24, i.e. the stacked Nd—Fe—B magnets includes two Nd—Fe—B magnets being stacked together. It should be appreciated that the method of the present invention can be used to stack between 2 to 50 Nd—Fe—B magnets together.

Then, the stacked Nd—Fe—B magnet is cured by heating the stacked Nd—Fe—B magnet in the clamping tool under the predetermined clamping pressure in a furnace at a predetermined temperature of between 20° C. and 250° C. for a predetermined duration of between 0.1 hr and 24 hr to produce a cured Nd—Fe—B magnet 20. In other words, during the curing of the stacked Nd—Fe—B magnet, both the clamping tool and the stacked Nd—Fe—B magnet are subjected to the heat treatment. The cured Nd—Fe—B magnet 20 is then machined into a plurality of small Nd—Fe—B magnets. In other words, during the machining step, the cured Nd—Fe—B magnet 20 is divided into a plurality of small Nd—Fe—B magnets 30. To machine the cured Nd—Fe—B magnet 20, a wire cutting tool, a disc cutting tool, or a multi-wire cutting tool is used to cut and divide the cured Nd—Fe—B magnet 20 into the small Nd—Fe—B magnets 30. In addition, the machining step can also be used to dispose excessive insulating adhesive, if any, around the cured Nd—Fe—B magnets 20. After dividing the cured Nd—Fe—B magnet 20, the small Nd—Fe—B magnets 30 are subjected to a surface treatment process by phosphating and spraying the small Nd—Fe—B magnets to protect the surfaces of the small Nd—Fe—B magnets 30.

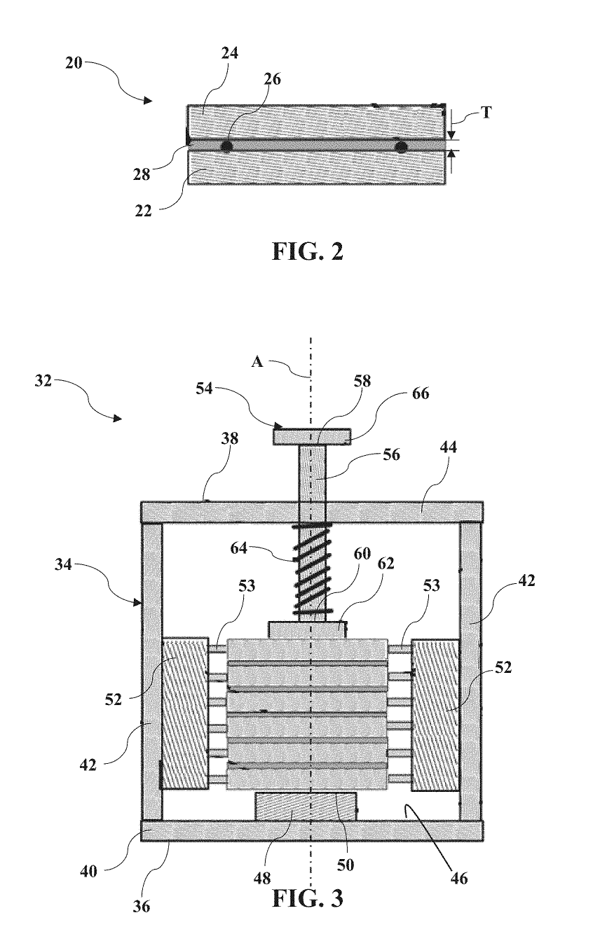

It is another aspect of the present invention to provide a cured Nd—Fe—B magnet 20. The cured Nd—Fe—B magnet 20, as best shown in FIG. 2, includes at least one first Nd—Fe—B magnet 22 and at least one second Nd—Fe—B magnet 24 disposed generally spaced and parallel to one another. It should be appreciated that the at least one first Nd—Fe—B magnet 22 and the at least one second Nd—Fe—B magnet 24 can be permanent Nd—Fe—B magnets or permanent Nd—Fe—B magnets containing Terbium or Dysprosium diffused therein. A layer 28 of an insulating adhesive is disposed between the at least one first Nd—Fe—B magnet 22 and the at least one second Nd—Fe—B magnet 24. A plurality of cured beads 26 of the insulating adhesive is dispose in the layer 28 between the at least one first Nd—Fe—B magnet 22 and the at least one second Nd—Fe—B magnet 24 to space and insulate the at least one first Nd—Fe—B magnet 22 from the at least one second Nd—Fe—B magnet 24. The plurality of cured beads 26 includes at least three cured beads 26 of the insulating adhesive, spaced from one another, between the at least one first Nd—Fe—B magnet 22 from the at least one second Nd—Fe—B magnet 24. It should be appreciated that, in one embodiment of the present invention, the insulating adhesive can be made from an epoxy resin and that each of the cured beads 26 and the layer 28 of the insulating adhesive can have a thickness T of between 0.03-0.5 mm.

It is a further aspect of the present invention to provide clamping tool 32 for applying the predetermined clamping pressure to the stacked Nd—Fe—B magnet. The clamping tool 32, as best shown in FIG. 3, includes a housing 34, having a generally U-shaped cross-section, disposed on a center axis A. The housing 34 extends between a first end 36 and a second end 38. The housing 34 includes a lower plate 40 and a pair of side plates 42. The lower plate 40 is disposed at the first end 36 of the housing 34. The pair of side plates 42, spaced from one another, extends perpendicularly outwardly from the lower plate 40, parallel to the center axis, to the second end 38. The housing 34 further includes a top plate 44 disposed at the second end 38 of the housing 34 to define a chamber 46 extending between the lower plate 40, the side plates 42, and the top plate 44 for receiving the stacked Nd—Fe—B magnet. It should be appreciated that the chamber 46 can be configured to receive a stacked Nd—Fe—B magnet made from up to 50 individual Nd—Fe—B magnets. A platform 48, having a generally convex surface 50, is disposed in the chamber 46 and attached to the lower plate 40 for engaging the stacked Nd—Fe—B magnet. A pair of magnet positioning members 52 disposed in the chamber 46 and attached to the side plates 42 for engaging and positioning the stacked Nd—Fe—B magnet in the chamber 46. It should be appreciated that the magnet positioning members 52 can include a plurality of protrusions 53 extending outwardly from the magnet positioning members 52 perpendicular to the center axis A for engaging the stacked Nd—Fe—B magnet.

A moving member 54 is disposed in the chamber 46 and movable along the center axis A for applying the predetermined clamping pressure to the stacked Nd—Fe—B magnet in the chamber 46 between the platform 48 and the moving member 54. The moving member 54 includes a shaft 56, having a generally cylindrical shape, extending through the top plate 44 along the center axis A between a primary end 58 and a secondary end 60. The primary end 58 of the moving member 54 is disposed outside the chamber 46 and spaced from the housing 34. The secondary end 60 is disposed in the chamber 46 axially spaced from the primary end 58. A head portion 62, having a generally circular shape, is disposed in the chamber 46 and attached to the secondary end 60 of the shaft 56 for axial movement with the shaft 56 and engage the stacked Nd—Fe—B magnet to sandwich the stacked Nd—Fe—B magnet between the head portion 62 and the platform 48. A spring 64 is disposed on the center axis A, in the chamber 46, and extends helically between the head portion 62 and the top plate 44 for biasing the head portion 62 toward the platform 48 to apply the predetermined clamping pressure. A handle 66, disposed at the primary end 58 of the shaft 56, is attached to the primary end 58 to allow a user to axially move the shaft 56 and the head portion 62 away from the platform 48 and the lower plate 40.

In operation, a user first pulls on the handle 66 to move the head portion 62 axially away from the platform 48. Next, the stacked Nd—Fe—B is disposed in the chamber 46 between the magnet positioning members 52, the platform 48, and the head portion 62. This is to ensure that, during the process of applying the predetermined clamping pressure, there will be no movement of the stacked Nd—Fe—B magnet in the chamber 46. After the stacked Nd—Fe—B magnet is properly positioned in the chamber 46, the handle 66 is released and the stacked Nd—Fe—B magnet is sandwiched between the head portion 62 and the platform 48. The spring 64 biases the head portion 62 toward the platform 48 and applies the predetermined clamping pressure of 0.1-20 MPa onto the stacked Nd—Fe—B magnet to spread the insulating adhesive evenly between the Nd—Fe—B magnets in the stacked Nd—Fe—B magnet.

Implementing examples are set forth below to provide a better illustration of the present invention. The implementing examples are used for illustrative purposes only and do not limit the scope of the present invention.

### Implementing Example 1

FIG. 2 best illustrates the clamping tool 32 in accordance with one embodiment of the present invention for applying the predetermined clamping pressure to the stacked Nd—Fe—B magnet. The clamping tool 32, as best shown in FIG. 3, includes a housing 34, having a generally U-shaped cross-section, disposed on a center axis A. The housing 34 extends between a first end 36 and a second end 38. The housing 34 includes a lower plate 40 and a pair of side plates 42. The lower plate 40 is disposed at the first end 36 of the housing 34. The pair of side plates 42, spaced from one another, extends perpendicularly outwardly from the lower plate 40, parallel to the center axis, to the second end 38. The housing 34 further includes a top plate 44 disposed at the second end 38 of the housing 34 to define a chamber 46 extending between the lower plate 40, the side plates 42, and the top plate 44 for receiving the stacked Nd—Fe—B magnet. It should be appreciated that the chamber 46 can be configured to receive a stacked Nd—Fe—B magnet made from up to 50 individual Nd—Fe—B magnets. A platform 48, having a generally convex surface 50, is disposed in the chamber 46 and attached to the lower plate 40 for engaging the stacked Nd—Fe—B magnet. A pair of magnet positioning members 52 disposed in the chamber 46 and attached to the side plates 42 for engaging and positioning the stacked Nd—Fe—B magnet in the chamber 46. The magnet positioning members 52 include a plurality of protrusions 53 extending outwardly from the magnet positioning members 52 perpendicular to the center axis A for engaging the stacked Nd—Fe—B magnet.

A moving member 54 is disposed in the chamber 46 and movable along the center axis A for applying the predetermined clamping pressure to the stacked Nd—Fe—B magnet in the chamber 46 between the platform 48 and the moving member 54. The moving member 54 includes a shaft 56, having a generally cylindrical shape, extending through the top plate 44 along the center axis A between a primary end 58 and a secondary end 60. The primary end 58 of the moving member 54 is disposed outside the chamber 46 and spaced from the housing 34. The secondary end 60 is disposed in the chamber 46 axially spaced from the primary end 58. A head portion 62, having a generally circular shape, is disposed in the chamber 46 and attached to the secondary end 60 of the shaft 56 for axial movement with the shaft 56 and engage the stacked Nd—Fe—B magnet to sandwich the stacked Nd—Fe—B magnet between the head portion 62 and the platform 48. A spring 64 is disposed on the center axis A, in the chamber 46, and extends helically between the head portion 62 and the top plate 44 for biasing the head portion 62 toward the platform 48 to apply the predetermined clamping pressure. A handle 66, disposed at the primary end 58 of the shaft 56, is attached to the primary end 58 to allow a user to axially move the shaft 56 and the head portion 62 away from the platform 48 and the lower plate 40.

In operation, a user first pulls on the handle 66 to move the head portion 62 axially away from the platform 48. Next, the stacked Nd—Fe—B is disposed in the chamber 46 between the magnet positioning members 52, the platform 48, and the head portion 62. This is to ensure that, during the process of applying the predetermined clamping pressure, there will be no movement of the stacked Nd—Fe—B magnet in the chamber 46. After the stacked Nd—Fe—B magnet is properly positioned in the chamber 46, the handle 66 is released and the stacked Nd—Fe—B magnet is sandwiched between the head portion 62 and the platform 48. The spring 64 biases the head portion 62 toward the platform 48 and applies the predetermined clamping pressure of 0.1-20 MPa onto the stacked Nd—Fe—B magnet to spread the insulating adhesive evenly between the Nd—Fe—B magnets in the stacked Nd—Fe—B magnet.

### Implementing Example 2

In Implement Example 2, square shaped Nd—Fe—B permanent magnets including grease on a surface of the Nd—Fe—B permanent magnets are first provided. The surface of the Nd—Fe—B permanent magnets is first cleaned using a solution containing 5% nitric acid. After washing the Nd—Fe—B permanent magnets, the surface of the Nd—Fe—B permanent magnets is phosphatized. Then, the surface of the Nd—Fe—B permanent magnets is washed using an alcohol to remove the grease. After washing, the surface of the Nd—Fe—B permanent magnets are activated using a plasma flame for 1 minute.

After activating the surface, a plurality of four beads of the insulating adhesive are disposed onto the surface of the Nd—Fe—B permanent magnets. Then, the Nd—Fe—B permanent magnets including the four beads are cured in a furnace under a curing temperature of 20° C. and for a curing duration of 24 hrs. After curing the Nd—Fe—B permanent magnets including the four beads, the thickness of the beads are 0.03 mm. It should be appreciated that the curing temperature, the curing duration, and the thickness of the beads can be varied and controlled based on specific requirements.

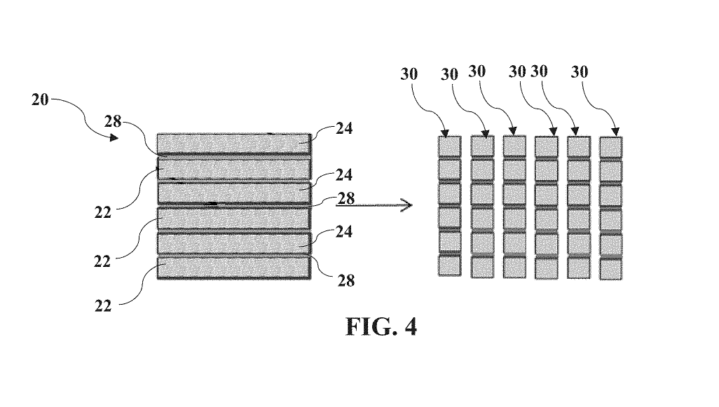

The surface of the Nd—Fe—B permanent magnets including the cured beads is then washed using the alcohol to remove the grease. After washing, the surface of the Nd—Fe—B permanent magnets including the cured beads are activated using a plasma flame for 1 minute. Next, a layer of the insulating adhesive is deposited on the surface of the Nd—Fe—B permanent magnets. Then, as best shown in FIG. 3, a plurality of six Nd—Fe—B permanent magnets including the layer of the insulating adhesive is stacked to form the stacked Nd—Fe—B magnet. A predetermined clamping pressure is then applied to the stacked Nd—Fe—B magnet. To apply the predetermined clamping pressure, the stacked Nd—Fe—B magnet is placed in the clamping tool and the predetermined pressure of between 0.1 MPa is applied to the stacked Nd—Fe—B magnet. Then, the stacked Nd—Fe—B magnet, disposed in the clamping tool, is cured by heating the stacked Nd—Fe—B magnet in a furnace at a predetermined temperature of between 20° C. for a predetermined duration of 24 hr to produce a cured Nd—Fe—B magnet. As best shown in FIG. 4, the cured Nd—Fe—B magnet is then machined into a plurality of six equal sized small Nd—Fe—B magnets using a disc cutting tool. After machining the cured Nd—Fe—B magnet, the small Nd—Fe—B magnets are subjected to a surface treatment process of phosphating.

### Implementing Example 3

In Implement Example 3, permanent Nd—Fe—B magnets containing Terbium or Dysprosium diffused therein are first provided. The surface of the permanent Nd—Fe—B magnets is first cleaned using a solution containing 3% nitric acid. After washing the permanent Nd—Fe—B magnets, the surface of the permanent Nd—Fe—B magnets is phosphatized. Then, the surface of the permanent Nd—Fe—B magnets is washed using an acetone to remove the grease. After washing, the surface of the permanent Nd—Fe—B magnets are activated using a low temperature plasma for 10 minutes.

After activating the surface, a plurality of six beads of the insulating adhesive are disposed onto the surface of the permanent Nd—Fe—B magnets. Then, the permanent Nd—Fe—B magnets including the six beads are cured in a furnace under a curing temperature of 200° C. and for a curing duration of 0.1 hr. After curing the permanent Nd—Fe—B magnets including the six beads, the thickness of the beads are 0.5 mm.

The surface of the permanent Nd—Fe—B magnets including the cured beads is then washed using the acetone to remove the grease. After washing, the surface of the permanent Nd—Fe—B magnets including the cured beads are activated using a plasma flame for 10 minute. Next, a layer of the insulating adhesive is deposited on the surface of the Nd—Fe—B permanent magnets. Then, a plurality of 50 permanent Nd—Fe—B magnets including the layer of the insulating adhesive is stacked to form the stacked Nd—Fe—B magnet. A predetermined clamping pressure is then applied to the stacked Nd—Fe—B magnet. To apply the predetermined clamping pressure, the stacked Nd—Fe—B magnet is placed in the clamping tool and the predetermined pressure of between 20 MPa is applied to the stacked Nd—Fe—B magnet. Then, the stacked Nd—Fe—B magnet, disposed in the clamping tool, is cured by heating the stacked Nd—Fe—B magnet in a furnace at a predetermined temperature of between 200° C. for a predetermined duration of 0.1 hr to produce a cured Nd—Fe—B magnet. The cured Nd—Fe—B magnet is then machined into two equal sized small Nd—Fe—B magnets using a multi-wire cutting tool. After machining the cured Nd—Fe—B magnet, the small Nd—Fe—B magnets are subjected to a surface treatment process of spraying.

### Implementing Example 4

In Implement Example 4, square shaped Nd—Fe—B permanent magnets including grease on a surface of the Nd—Fe—B permanent magnets are first provided. The surface of the Nd—Fe—B permanent magnets is first cleaned using a solution containing 5% nitric acid. After washing the Nd—Fe—B permanent magnets, the surface of the Nd—Fe—B permanent magnets is phosphatized. Then, the surface of the Nd—Fe—B permanent magnets is washed using an acetone to remove the grease. After washing, the surface of the Nd—Fe—B permanent magnets are activated using a low temperature plasma for 5 minutes.

After activating the surface, a plurality of four beads of the insulating adhesive are disposed onto the surface of the Nd—Fe—B permanent magnets. Then, the Nd—Fe—B permanent magnets including the four beads are cured in a furnace under a curing temperature of 150° C. and for a curing duration of 1.5 hrs. After curing the Nd—Fe—B permanent magnets including the four beads, the thickness of the beads are 0.1 mm.

The surface of the Nd—Fe—B permanent magnets including the cured beads is then washed using an alcohol to remove the grease. After washing, the surface of the Nd—Fe—B permanent magnets including the cured beads are activated using a low temperature plasma for 5 minutes. Next, a layer of the insulating adhesive is deposited on the surface of the Nd—Fe—B permanent magnets. Then, a plurality of two Nd—Fe—B permanent magnets including the layer of the insulating adhesive is stacked to form the stacked Nd—Fe—B magnet. A predetermined clamping pressure is then applied to the stacked Nd—Fe—B magnet. To apply the predetermined clamping pressure, the stacked Nd—Fe—B magnet is placed in the clamping tool and the predetermined pressure of between 1 MPa is applied to the stacked Nd—Fe—B magnet. Then, the stacked Nd—Fe—B magnet, disposed in the clamping tool, is cured by heating the stacked Nd—Fe—B magnet in a furnace at a predetermined temperature of between 150° C. for a predetermined duration of 1.5 hr to produce a cured Nd—Fe—B magnet. The cured Nd—Fe—B magnet is then machined into a plurality of 50 equal sized small Nd—Fe—B magnets using a wire cutting tool. After machining the cured Nd—Fe—B magnet, the small Nd—Fe—B magnets are subjected to a surface treatment process of phosphating.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A method of segmenting a stacked Nd—Fe—B magnet, said method comprising the steps of:
providing a first Nd—Fe—B magnet and a second Nd—Fe—B magnet with the first Nd—Fe—B magnet and the second Nd—Fe—B magnet including rust and grease disposed on a surface of the first Nd—Fe—B magnet and the second Nd—Fe—B magnet;
cleaning the surface of the first Nd—Fe—B magnet and the second Nd—Fe—B magnet to remove the rust and the grease from the first Nd—Fe—B magnet and the second Nd—Fe—B magnet;
depositing an insulating adhesive onto the surface of the first Nd—Fe—B magnet;
curing the first Nd—Fe—B magnet including the insulating adhesive;
cleaning the surface of the first Nd—Fe—B magnet including the insulating adhesive;
depositing a layer of the insulating adhesive on the surface of the first Nd—Fe—B magnet and the second Nd—Fe—B magnet;
stacking the first Nd—Fe—B magnet and the second Nd—Fe—B magnet to sandwich the layer of the insulating adhesive on the surface of the second Nd—Fe—B magnet and the layer of insulating adhesive and the beads of the first adhesive on the surface of the first Nd—Fe—B magnet between the first Nd—Fe—B magnet and the second Nd—Fe—B magnet to produce a staked Nd—Fe—B magnet;
applying a predetermined clamping pressure to the stacked Nd—Fe—B magnet;
curing the stacked Nd—Fe—B magnet to produce a cured Nd—Fe—B magnet;
machining the cured Nd—Fe—B magnet to divide the cured Nd—Fe—B magnet into a plurality of small Nd—Fe—B magnets; and
said step of depositing the insulating adhesives being further defined as depositing a plurality of beads of the insulating adhesive onto the surface of the first Nd—Fe—B magnet.

2. The method as set forth in claim 1 wherein said step of depositing the plurality of beads is further defined as depositing at least three beads of the insulating adhesive spaced from one another onto the surface of the first Nd—Fe—B magnet.

3. The method as set forth in claim 1 wherein said step of depositing the plurality of beads is further defined as depositing the plurality of beads of the insulating adhesive of an epoxy resin onto the surface of the first Nd—Fe—B magnet.

4. The method as set forth in claim 1 wherein said step of providing the first Nd—Fe—B magnet and the second Nd—Fe—B magnet is further defined as providing the first Nd—Fe—B magnet and the second Nd—Fe—B magnet with the first Nd—Fe—B magnet and the second Nd—Fe—B magnet being permanent Nd—Fe—B magnets or permanent Nd—Fe—B magnets containing Terbium or Dysprosium diffused therein.

5. The method as set forth in claim 1 wherein said step of curing the first Nd—Fe—B magnet including the insulating adhesive is further defined as heating the first Nd—Fe—B magnet including the insulating adhesive in a furnace under a curing temperature of between 20° C. to 200° C. for a curing duration of between 0.1 hour and 24 hours to solidify the insulating adhesive with the insulating adhesive having a thickness of between 0.03 mm and 0.5 mm.

6. The method as set forth in claim 1 wherein said step of machining the cured Nd—Fe—B magnet is further defined as using a wire-cutting tool, disc cutting tool, or a multi-wire cutting tool to divide the cured Nd—Fe—B magnet into the small Nd—Fe—B magnets.

7. The method as set forth in claim 6 further including a step of surface treating the small Nd—Fe—B magnets.

8. The method as set forth in claim 7 wherein said said step of surface treating is further defined as phosphating and spraying the small Nd—Fe—B magnets.

9. The method as set forth in claim 1 wherein said step of cleaning being further defined as acid washing, phosphating, or sand blasting the surface of the first Nd—Fe—B magnet and the second Nd—Fe—B magnet.

10. The method as set forth in claim 1 wherein said step of cleaning the surface of the first Nd—Fe—B magnet further including a step of removing the rust and the grease from the surface of the first Nd—Fe—B magnet and the second Nd—Fe—B magnet.

11. The method as set forth in claim 10 wherein said step of removing the rust and the grease being further defined as washing the surface of the first Nd—Fe—B magnet and the second Nd—Fe—B magnet using a solution selected from at least one alcohol or acetone to remove the grease and the rust from the first Nd—Fe—B magnet and the second Nd—Fe—B magnet.

12. The method as set forth in claim 10 wherein said step of cleaning the surface of the first Nd—Fe—B magnet and the second Nd—Fe—B magnet further including a step of activating the surface of the first Nd—Fe—B magnet and the second Nd—Fe—B magnet following said step of washing.

13. The method as set forth in claim 12 wherein said step of activating is further defined as subjecting the surface of the first Nd—Fe—B magnet and the second Nd—Fe—B magnet to a plasma cleaning process using a low temperature plasma or a plasma flame.

14. The method as set forth in claim 1 wherein said step of applying the predetermined clamping pressure is further defined as disposing the stacked Nd—Fe—B magnet in a clamping tool and applying the predetermined clamping pressure of between 0.1 MPa and 20 MPa to the first Nd—Fe—B magnet and the second Nd—Fe—B magnet.

15. The clamping tool as set forth in claim 14 for applying the predetermined clamping pressure to the stacked Nd—Fe—B magnet, the clamping tool comprising:
a housing of a generally U-shaped cross-section disposed on a center axis and extending between a first end and a second end;
said housing including a lower plate disposed at said first end and a pair of side plates disposed spaced from one another and extending perpendicularly outwardly from said lower plate parallel to said center axis to said second end;
a top plate disposed at said second end of said housing and defining a chamber extending between said lower plate and said side plates and said top plate for receiving the stacked Nd—Fe—B magnet;
a platform having a convex surface disposed in said chamber and attached to said lower plate for engaging the stacked Nd—Fe—B magnet;
a pair of magnet positioning members disposed in said chamber and attached to said side plates for engaging and positioning the stacked Nd—Fe—B magnet;
a moving member disposed in said chamber and movable along said center axis for applying the predetermined clamping pressure to the stacked Nd—Fe—B magnet between said platform and said moving member;
said moving member including a shaft of generally cylindrical shape extending from a primary end and a secondary end with said primary end being disposed outside said chamber and said secondary end being disposed in said chamber axially spaced from said primary end;
a head portion of generally circular shape disposed in said chamber and attached to said secondary end of said shaft for axial movement with said shaft and engage the the stacked Nd—Fe—B magnet to sandwich the Nd—Fe—B magnets between said head portion and said platform;
a spring disposed on said center axis in said chamber and extending helically between said head portion and said top plate for biasing said head portion toward said platform to apply the predetermined clamping pressure; and
a handle disposed at said primary end of said shaft and attached to said primary end to allow a user to axially move said shaft and said head portion away from said platform and said lower plate.

16. A cured Nd—Fe—B magnet comprising:
at least one first Nd—Fe—B magnet and at least one second Nd—Fe—B magnet disposed spaced and generally parallel to one another;
a layer of an insulating adhesive disposed between said at least one first Nd—Fe—B magnet and said at least one second Nd—Fe—B magnet; and
a plurality of cured beads of said insulating adhesive being dispose in said layer between said at least one first Nd—Fe—B magnet and said at least one second Nd—Fe—B magnet to space and insulate said at least one first Nd—Fe—B magnet from said at least one second Nd—Fe—B magnet.

17. The cured Nd—Fe—B magnet as set forth in claim 16 wherein said plurality of cured beads includes at least three cured beads of said insulating adhesive, spaced from one another, between said at least one first Nd—Fe—B magnet from said at least one second Nd—Fe—B magnet.

18. The cured Nd—Fe—B magnet as set forth in claim 17 wherein each of said cured beads and said layer of said insulating adhesive have a thickness of between 0.03-0.5 mm.

19. The cured Nd—Fe—B magnet as set forth in claim 16 wherein said insulating adhesive is made from an epoxy resin.

20. The cured Nd—Fe—B magnet as set forth in claim 16 wherein said at least one first Nd—Fe—B magnet and said at least one second Nd—Fe—B magnet are permanent Nd—Fe—B magnets or permanent Nd—Fe—B magnets containing Terbium or Dysprosium diffused therein.
